(19) United States
(12) Patent Application Publication
(10) Pub. No.: US 2022/0087302 A1
(43) Pub. Date: Mar. 24, 2022

(54) FRENCH FRIES WITH INTERNAL FILLING

(71) Applicants: Jayde WOOD, Vancouver (CA); Daniel WOOD, Vancouver (CA)

(72) Inventors: Jayde WOOD, Vancouver (CA); Daniel Wood, Vancouver (CA)

(21) Appl. No.: 17/481,449

(22) Filed: Sep. 22, 2021

(30) Foreign Application Priority Data
Sep. 23, 2020 (CA) 3093950

(51) Int. Cl. A23P 20/25; A23L 19/18; A23L 29/10; A23L 17/00; A23L 33/15; A23L 19/00

(52) U.S. Cl. CPC A23P 20/25; A23L 19/18; A23L 19/09; A23L 17/70; A23L 33/15; A23L 29/10

(57) ABSTRACT

French fries having a potato shell and a solid core disposed within and substantially enclosed by potato shell are provided. The potato shell has a composition that is different from the solid core. The solid core may include fish, meat, cheese, non-potato vegetables, or potatoes that have been fortified with micronutrients, protein, and/or essential fatty acids.

### TECHNICAL FIELD

The present invention relates to a French fries-type food item. In particular, the present invention relates to a French fries-type food item with an internal filling.

### BACKGROUND

French fries, or simply fries, are a much-loved food item. They are batonnet-cut deep-fried potatoes and well liked for their textural dichotomy having a crisp exterior and a tender, moist interior. According to a study conducted by the U.S. Department of Agriculture's Economic Research Services, potatoes are one of the most commonly consumed vegetables, and fries contribute to the high consumption of potatoes. The results of the study are available on the U.S. Department of Agriculture's website at: https://www.ers.usda.gov/data-products/chart-gallery/gallery/chart-detail/?chartId=58340. On average, one American eats about 30 pounds of fries per year.

However, fries are not particularly nutritious and may contain high amounts of sodium, carbohydrates, and trans fats. The U.S. Department of Agriculture National Nutrient Database for Standard Reference reports that 20 frozen fries contain: 365 calories, 28 grams of carbohydrates, 5 grams of fat, and 3 grams of protein. Some fries contain trans fat and high sodium content, the consumption of which can increase the risk of heart disease and type 2 diabetes.

Also, without any seasoning or dipping sauce, fries lack taste diversity such that one may not desire to eat plain fries over and over again.

There is a general desire for French fries with improved nutritional value, while maintaining a sensory quality that is comparable to high quality deep-fried fries. There is also a general desire for French fries with an improved sensory profile.

The foregoing examples of the related art and limitations related thereto are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

One aspect of the invention provides a French fries-type food item with improved nutritional value and/or sensory profile, while maintaining a sensory quality that is comparable to high quality deep-fried fries.

The French fries-type food item may be French fries.

The French fries-type food item has a potato shell and a solid core disposed within an interior portion of the shell. The core is substantially enclosed by the shell. The potato shell has a first composition. The solid core has a second composition. The first composition differs from the second composition.

The solid core may have fish, meat, cheese, nut butters, non-potato vegetables, fruits, or potatoes that are fortified with micronutrients, protein, or essential fatty acids.

The potato shell may have a water activity level that is about the same as that of the solid core.

The potato shell may have a water activity level that is different than that of the solid core. In such an embodiment, an edible moisture barrier may be sandwiched between the potato shell and solid core to prevent moisture migration between the potato shell and the solid core.

Another aspect relates to a method for making a French fries-type food item. A solid core is prepared and is enclosed by a potato shell. The potato shell has a first composition. The solid core has a second composition. The first composition differs from the second composition.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 shows a perspective view of a French fry according to an embodiment of the present invention.

FIG. 2 shows a cross-sectional view of the embodiment of FIG. 1 taken along section 2-2, which is shown in FIG. 1.

FIG. 3 shows a block diagram showing a method for making a French fry according to an embodiment of the present invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

As used herein, the terms “about” or “approximately” mean a value within +/−10% of the stated value unless specified otherwise, and either one of these terms connotes that strict compliance with the numeric value recited is not critical but some variation is permissible and still within the scope of the various embodiments described herein.

As used herein, the term “substantially” means generally and not absolutely. For example, a French fry according to the present invention may have a potato shell and a core that is disposed within the potato shell. The core is “substantially enclosed” by the shell. The expression “substantially enclosed” means that the core is not readily visible from a visual examination of the French fry.

As used herein, the term “liquid” means any material that has a viscosity of 100,000 centipoise (cps) or less at room temperature. Some example liquids include ketchup and mustard. As used herein, the term “solid” means any material that has a viscosity of 150,000 or more at room temperature. Some example solids include peanut butter and mashed potato.

As used herein, the terms “potato” and “potatoes” are used broadly to include any type of common potato, i.e. Solanum tuberosum, and sweet potatoes, i.e. Ipomoea batatas.

As used herein, the term “French fries-type food item” refers to any food item that has a crispy fried exterior and a tender, moist interior. Some example French fries-type food items include hash browns and tater tots.

As used herein, the terms “cooking” and “cooked” are to be understood in contrast with “raw” or “uncooked”. The term “cooking” refers to any cooking method, including frying, baking, boiling, microwaving, broiling, poaching, steaming, sautéing, and any other method of cooking a food item.

Embodiments of the present invention provide:
A French fry having (i) a potato shell and (ii) a solid core disposed in and enclosed by the potato shell; and
A process for making a French fry that has (i) a potato shell and (ii) a solid core disposed in and enclosed by the potato shell.

### Multi-Layered French Fries

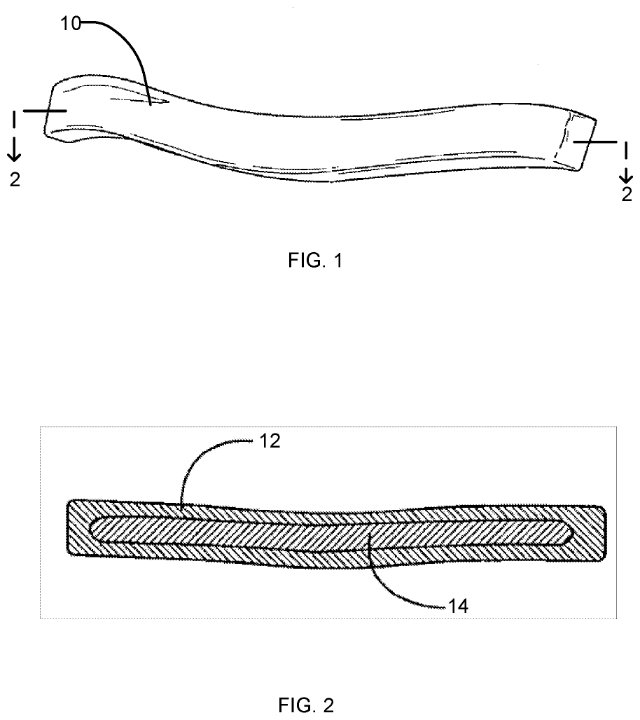

FIG. 1 shows a perspective view of a French fry 10 that may have the same appearance as a prior-art fry. FIG. 2 shows a cross-sectional view of French fry 10 and this cross-sectional view illustrates the inventive features of French fry 10 in contrast with the prior-art fry.

French fry 10 has a potato shell 12 and a core 14. Core 14 is disposed in potato shell 12 and is substantially or entirely enclosed by potato shell 12 such that core 14 is not visible from a visual examination of French fry 10. The percentage volume that core 14 may occupy of the total volume of French fry 10 may be about 5% to about 95% and include any value therebetween, including 10%, 15%, 20%, 25%, 30%, 35%, 40%, 45%, 50%, 55%, 60%, 65%, 70%, 75%, 80%, 85%, and 90%.

Potato shell 12 and core 14 have different compositions. Potato shell 12 comprises potatoes, either cooked or raw, and makes up the outer portion of French fry 10.

In contrast, core 14 has a different composition than that of potato shell 12. Core 14 may comprise cooked and mashed fish, including Pacific Cod, Flounder, Halibut, Lingcod, Mahi Mahi, Pollock, and Rockfish. Mild fish may be desirable so that the sensory quality of French fry 12 does not deviate significantly from high quality deep-fried fries. Once the fish is cooked, the cooked fish may be dried and salted prior to being mashed. The drying and salting steps may function to (i) calibrate the water activity level of the mashed fish so that potato shell 12 and fish core 14 have the same water activity level and (ii) control the taste profile of fish core 14. It may be desirable because if potato shell 12 and fish core 14 have the same water activity level, there is no driving force for moisture migration between potato shell 12 and core 14. Moisture migration between potato shell 12 and core 14 is undesirable because it may cause quality deterioration and unwanted textual changes. The cooking process of fish may diminish its nutritional profile. For example, omega-3 content in fish may be destroyed during the cooking process. To restore the cooked fish's nutritional profile, the mashed fish may be fortified. For example, core 14 comprising cooked and mashed fish may be coated with a mixture of omega fatty acids and an antioxidant. The omega fatty acids may be omega-3 fatty acids and/or omega-6 fatty acids. The antioxidant may be natural, including vitamin E, curcumin, flavonoids, and vitamin C, or synthetic, including Butylated hydroxyanisole, butylated hydroxytoluene, tert-Butylhydroquinone, propyl gallate, and ethoxyquin. In another example, core 14 comprising cooked and mashed fish may be plated with omega fatty acids. The plated core may be coated with a zein solution and then dried. The zein solution may be about 1% to about 95% zein by weight.

Core 14 may comprise cooked and mashed non-potato vegetables, including cauliflower and rutabaga. It may be desirable to select a non-potato vegetable that does not have a strong taste profile or a colour appearance that differs significantly from potatoes so that the sensory quality of French fry 12 does not deviate significantly from high quality deep-fried fries. Also, herbs, spices, and/or parmesan cheese may be added and mixed with the mashed non-potato vegetable to mask an undesirable vegetable taste and to improve the overall taste of French fry 10. In some embodiments, the mashed non-potato vegetable may be further processed to reduce its water activity level so that potato shell 12 and fish core 14 have the same water activity level such that there is no driving force for moisture migration between potato shell 12 and core 14.

Core 14 may comprise potatoes although such potatoes will have a different composition, i.e. its nutritional profile, than that of potato shell 12. For example, the potatoes of core 14 may be fortified with micronutrients, protein, and/or essential fatty acids. The nutritional profile and/or taste profile of core 14 may be adjusted by mixing the potatoes of core 14 with other ingredients, including meat, cheese, and/or non-potato vegetables. For example, the potatoes of core 14 may be mixed with bacon bits. The potatoes of core 14 may be mixed with cheese and gravy. The potatoes of core 14 may be mixed with sour cream, bacon, and green onion.

In some embodiments, potato shell 12 and core 14 may have different levels of water activity. To prevent moisture migration between potato shell 12 and core 14, an edible moisture barrier (not shown) is created between potato shell 12 and core 14. In such embodiments, the barrier is sandwiched between core 14 and potato shell 12 such that core 12 is encased in the barrier and potato shell 12 surrounds the barrier. The barrier may be an edible oleaginous material. The barrier may be a milk-protein-based film. The barrier may have at least one emulsifier and the emulsifier may be mono and di-glycerides, phospholipids, egg or soy lecithin, sucrose fatty acid esters, polyglycerol fatty acid, and any combination thereof.

### Process for Making Multi-Layered French Fries

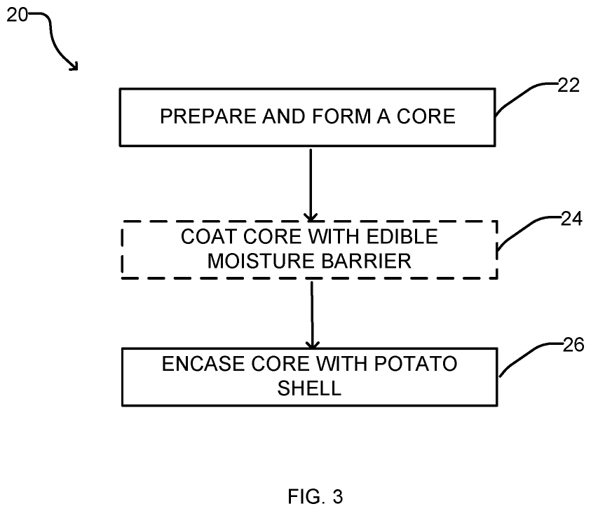

FIG. 3 schematically illustrates a method 20 for making French fry 10.

Method 20 starts in step 22 where core 14 is prepared and formed.

In some embodiments, core 14 may be prepared by cooking, seasoning, and mashing a mild fish. Such mild fish may include Pacific Cod, Flounder, Halibut, Lingcod, Mahi Mahi, Pollock, and Rockfish. The mashed fish may have a water activity level of about 0.45 to about 0.5 and a moisture content level of about 55% to about 80%. The mashed fish is then moulded into a particular shape, for example a generally-cylindrical shape or a generally-rectangular cuboid. A generally-cylindrical shaped core 14 may have a diameter of about ⅛ inch and a length of about 1 inch. A generally-rectangular cuboid shaped core 14 may have a width of about ⅛ inch, a height of about ⅛ inch, and a length of about 1 inch. The dimensions of core 14 may vary as long as core 14 will be substantially enclosed by potato shell 12. The percentage volume that core 14 may occupy of the total volume of French fry 10 may be about 5% to about 95% and include any value therebetween, including 10%, 15%, 20%, 25%, 30%, 35%, 40%, 45%, 50%, 55%, 60%, 65%, 70%, 75%, 80%, 85%, and 90%.

To restore the cooked fish's nutritional profile, the mashed fish may be fortified. For example, core 14 comprising cooked and mashed fish may be coated with a mixture of omega fatty acids and an antioxidant. The omega fatty acids may be omega-3 fatty acids and/or omega-6 fatty acids. The antioxidant may be natural, including vitamin E, curcumin, flavonoids, and vitamin C, or synthetic, including Butylated hydroxyanisole, butylated hydroxytoluene, tert-Butylhydroquinone, propyl gallate, and ethoxyquin. In another example, core 14 comprising cooked and mashed fish may be plated with omega fatty acids. The plated core may be coated with a zein solution and then dried. The zein solution may be about 1% to about 95% zein by weight.

In some embodiments, core 14 is prepared by cooking and mashing non-potato vegetables. Such non-potato vegetables may be cauliflower and rutabaga. To adjust the water activity level of the mashed non-potato vegetables, the mashed non-potato vegetables may be dried and/or seasoned. For example, herbs, spices, and/or parmesan cheese may be mixed with the mashed non-potato vegetables. Also, the mashing process may use a blender to create a creamy texture for the cooked non-potato vegetables. The mashed non-potato vegetable may have a water activity level of about 0.45 to about 0.5 and a moisture content level of about 55% to about 80%. The mashed non-potato vegetable is then moulded into any suitable shape and dimensions.

In some embodiments, core 14 is prepared by cooking and mashing potatoes. The potatoes have a different composition, i.e. its nutritional profile, than that of potato shell 12. For example, the potatoes of core 14 may be fortified with micronutrients, protein, and/or essential fatty acids. The potatoes of core 14 may be a different variety of potatoes with a nutritional profile that differs from that of potato shell 12.

Once core 14 is formed, core 14 is optionally coated with an edible moisture barrier at step 24. The barrier may be an edible oleaginous material. The barrier may be a milk-proteins-based film. The barrier may have at least one emulsifier and the emulsifier may be mono and di-glycerides, phospholipids, egg or soy lecithin, sucrose fatty acid esters, polyglycerol fatty acid, and combinations thereof.

Core 14 is then substantially enclosed by potato shell 12. In embodiments where an edible moisture barrier is present, the barrier is sandwiched between core 14 and potato shell 12 such that core 12 is encased in the barrier and potato shell 12 surrounds the barrier. To enclose core 14 by potato shell 12, cooked potatoes may fill a bottom portion of a French fry mould; core 14 is then placed in the French fry mould; and more cooked potatoes fill the remaining space of the French mould.

To enclose core 14 within shell 12, a French fry mould may be used. A bottom portion of the French fry mould is first filled with cooked and mashed potato. Core 14 is then placed on the potato that has been filled on the bottom portion of the French fry mould. Core 14 is placed in a middle portion of the French fry mould. The remaining space of the French fry mould is then filled with cooked and mashed potato. The filled material is compressed to form a French fry 10.

French fries 10 may be produced on a commercial scale. For example, raw potatoes first pass through abrasive brushes that scrape any foreign debris like dirt, rocks, or potato eyes from the skin. Potatoes then pass through a water jet washing station to remove any residual debris and thoroughly clean the potatoes. The cleaned raw potatoes are optionally sorted according to their sizes. For example, the cleaned raw potatoes are sorted on successive levels of vibrating grids, wherein smaller potatoes are separated from the larger ones by falling through the gaps in the grids on to collection platforms below. The cleaned potatoes are pre-processed, e.g. by way of steam, hot water, or electricity, in order to assist in the subsequent skin removal. The pre-processed potatoes are deskinned and cooked. The cooked potatoes may then be soaked in successive baths, first soaking in boiling water to remove the sugar content and then into cold water to enhance the potato flavour. The cooked potatoes are flattened and pressed to provide a continuous sheet. The continuous sheet may be dried, e.g. for a period of time under a blower. The dried continuous sheet is then cut to provide a plurality of wrappers, with the wrappers having any suitable dimensions. Core 14 is then added to the center of a wrapper e.g. by a mechanical arm. The wrapper is then folded around core 14 to thereby enclosing core 14 and fry 10, forming shell 12. Fry 10 may be fried by being soaked in a non-hydrogenated vegetable oil bath, e.g. for two to three minutes. Fried fries 10 are then seasoned, cooled, frozen, and packaged.

In another example, instead of starting with raw potatoes, potato starch may be used. For example, potato dough may be made by mixing potato starch and water. The potato dough is then rolled and flattened to provide a continuous sheet. The continuous sheet is cut using a shape specific cutter to provide a plurality of wrappers, with the wrappers having any suitable dimensions. Core 14 is then added to the center of a wrapper e.g. by a mechanical arm. The wrapper is then folded around core 14 to thereby enclose core 14 and fry 10, forming shell 12. Fry 10 may be fried by being soaked in a non-hydrogenated vegetable oil bath, e.g. for two to three minutes. Fried fries 10 are then seasoned, cooled, frozen, and packaged.

French fry 10 may be pre-fried, par-fried, and then frozen.

### Example 1—French Fries with Cod Core

50 grams of cod fillet is marinated in salt and cooking wine for 3 hours.

The marinated fillet is steamed for 10 minutes.

The steamed fish is lightly dabbed dry with paper towel.

The steamed fish is blended with 10 grams of olive oil, one roasted garlic clove, and 10 gram of parmesan cheese in a food processor.

The blended mixture has a water activity level of about 0.6.

The blended mixture is formed in multiple pieces each being generally-cylindrical shaped with a diameter of about 1/10 inch and a length of about 0.5 inch.

50 grams of russet potato is steamed for 15 minutes until the potato becomes tender.

Spread 5 grams of steamed potato evenly on the bottom of a French fry mould.

Place one piece of the generally-cylindrical shaped cod mixture in the French fry mould. The generally-cylindrical shaped cod mixture is placed above the evenly spread steamed potato that has been placed on the bottom of the mould and the generally-cylindrical shaped cod mixture is also placed in a middle portion of the mould.

Fill the remaining space of the mould with another 5 grams of steamed potato.

Compress the food in the mould and remove the compressed item from the mould to form a French fry.

Fry the French fry.

The fried French fry has a surface water activity of about 0.5 and an internal moisture content of about 60%.

### Example 2—French Fries with a Fortified Core

One russet potato is washed, peeled, and cut into pieces. Each piece has a width of about ¼ inch, a height of about ¼ inch, and a length of about 2 inches.

Each piece is hollowed by removing about 50% of the material along a central line.

The removed potato is about 100 grams and is steamed.

The steamed potato is blended with a mixture containing omega-6 fatty acids, omega-3 fatty acids, and vitamin E to deliver about 10 mg fatty acids per 10 grams of steamed potato. The ratio of omega-6 fatty acids to omega-3 fatty acids by weight is about 0.03:1. The total fatty acids concentration is about 100 ppm. The concentration of vitamin E is about 10 ppm.

The blended potato mixture is loaded and compressed in the interior space of the hollowed pieces to provide French fries.

Fry the French fries.

The fried French fry has a surface water activity of about 0.5 and an internal moisture content of about 50%.

### Example 3—French Fries with Coated Core

50 grams of cod fillet is marinated in salt and cooking wine for 3 hours.

The marinated fillet is steamed for 10 minutes.

The steamed fish is lightly dabbed dry with paper towel.

The steamed fish is blended with 10 grams of olive oil, one roasted garlic clove, and 10 grams of parmesan cheese in a food processor.

The blended mixture has a water activity level of about 0.6.

The blended mixture is formed in multiple pieces each being generally-cylindrical shaped with a diameter of about 1/10 inch and a length of about 0.5 inch.

Each generally-cylindrical shaped fish mixture is coated with a mixture containing omega-6 fatty acids, omega-3 fatty acids, and vitamin E to deliver about 10 mg fatty acids per 10 grams of steamed potato. The ratio of omega-6 fatty acids to omega-3 fatty acids by weight is about 0.03:1. The total fatty acids concentration is about 100 ppm. The concentration of vitamin E is about 10 ppm.

50 grams of russet potato is steamed for 15 minutes until the potato becomes tender.

Spread 5 grams of steamed potato evenly on the bottom of a French fry mould.

Place one piece of the generally-cylindrical shaped cod mixture in the French fry mould. The generally-cylindrical shaped cod mixture is placed above the evenly spread steamed potato that has been placed on the bottom of the mould and the generally-cylindrical shaped cod mixture is also placed in a middle portion of the mould.

Fill the remaining space of the mould with another 5 grams of steamed potato.

Compress the food in the mould and remove the compressed item from the mould to form a French fry.

Fry the French fry.

The fried French fry has a surface water activity of about 0.5 and an internal moisture content of about 60%.

### Example 4—French Fries with Mashed Cauliflower Core

One russet potato is washed, peeled, and cut into pieces. Each piece has a width of about ¼ inch, a height of about ¼ inch, and a length of about 2 inches.

Each piece is hollowed by removing about 50% material along a central line.

Steam 50 grams of cauliflower for about 10 minutes until tender.

Heat olive oil in a small skillet over medium heat. Cook and stir a garlic clove for about 2 minutes until softened.

Blend the steamed cauliflower in a food processor.

Blend in cooked garlic, 5 grams of parmesan cheese, 5 grams of cream cheese, and some salt and pepper.

Load and compress the blended cauliflower in the interior space of the hollowed pieces to provide French fries.

Fry the French fries.

On average, the fried French fries have a surface water activity of about 0.6 and an internal moisture content of about 65%.

### Example 5—French Fries with Moisture Barrier

50 grams of cod fillet is marinated in salt and cooking wine for 3 hours.

The marinated fillet is steamed for 10 minutes.

The steamed fish is lightly dabbed dry with paper towel.

The steamed fish is blended with 10 grams of olive oil, one roasted garlic clove, and 10 grams of parmesan cheese in a food processor.

The blended mixture has a water activity level of about 0.6.

The blended mixture is formed in multiple pieces each being generally-cylindrical shaped with a diameter of about 1/10 inch and a length of about 0.5 inch.

Each generally-cylindrical shaped fish mixture is coated with a mixture containing omega-6 fatty acids, omega-3 fatty acids, and vitamin E to deliver about 10 mg fatty acids per 10 grams of steamed potato. The ratio of omega-6 fatty acids to omega-3 fatty acids by weight is about 0.03:1. The total fatty acids concentration is about 100 ppm. The concentration of vitamin E is about 10 ppm.

The coated generally-cylindrical shaped fish mixture is then dipped in an edible material consisting of a major portion by weight of edible oleaginous materials (oils and fats) and a minor portion by weight of edible wax. The fish mixture is then dried so that the edible oleaginous material forms an edible moisture barrier encasing the fish mixture.

50 grams of russet potato is steamed for 15 minutes until the potato becomes tender.

Spread 5 grams of steamed potato evenly on the bottom of a French fry mould.

Place one piece of the generally-cylindrical shaped cod mixture in the French fry mould. The generally-cylindrical shaped cod mixture is placed above the evenly spread steamed potato that has been placed on the bottom of the mould and the generally-cylindrical shaped cod mixture is also placed in a middle portion of the mould.

Fill the remaining space of the mould with another 5 grams of steamed potato.

Compress the food in the mould and remove the compressed item from the mould to form a French fry.

### Example 6—French Fries Made with Potato Starch

50 grams of cod fillet is marinated in salt and cooking wine for 3 hours.

The marinated fillet is steamed for 10 minutes.

The steamed fish is lightly dabbed dry with paper towel.

The steamed fish is blended with 10 grams of olive oil, one roasted garlic clove, and 10 grams of parmesan cheese in a food processor.

The blended mixture has a water activity level of about 0.6.

The blended mixture is formed in multiple pieces each being generally-cylindrical shaped with a diameter of about 1/10 inch and a length of about 0.5 inch.

Mix 30 grams of potato starch with 10 grams of water to make potato dough.

Roll and flatten the potato dough to provide a continuous sheet. The sheet has a thickness about ¼ inch.

Cut the sheet into generally-square pieces. Each piece is about 2 inch in length and 2 inch in width.

The generally-cylindrical shaped fish mixture is added to the center of the generally-square potato piece.

The generally-square potato piece is folded to enclose the generally-cylindrical shaped fish mixture.

The assembled food item is then placed in a French fry mould and compressed to form a fry shape.

Fry the French fries.

On average, the fried French fries have a surface water activity of about 0.6 and an internal moisture content of about 65%.

Although the description focuses on French fries, a person skilled in the art will understand that the technology disclosed herein is also applicable to other French fries-type food items, including harsh browns and tater tots

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are consistent with the broadest interpretation of the specification as a whole.

1. A French fries-type food item comprising:
a potato shell;
a solid core disposed within and substantially enclosed by potato shell; and
an edible moisture barrier sandwiched between the potato shell and the solid core, the edible moisture barrier configured to prevent moisture migration between the potato shell and the solid core;
wherein:
the potato shell has a first composition;
the solid core has a second composition;
the first composition differs from the second composition;
the solid core is substantially enclosed by the edible moisture barrier; and
the edible moisture barrier is substantially enclosed by the potato shell.

2. The French fries-type food item as defined in claim 1 being a French fry.

3. The French fries-type food item as defined in claim 1, wherein:
the potato shell has a first water activity level;
the solid core has a second water activity level; and
the first activity level is about the same as the second activity level.

4. The French fries-type food item as defined in claim 3, wherein the first activity level and the second activity level are about 0.5.

5. The French fries-type food item as defined in claim 1, wherein:
the potato shell has a first water activity level;
the solid core has a second water activity level; and
the first activity level differs from the second activity level.

6. The French fries-type food item as defined in claim 1, wherein the first composition and the second composition contain non-overlapping ingredients.

7. The French fries-type food item as defined in claim 1, wherein the edible moisture barrier comprises an edible oleaginous material or a milk-proteins-based film.

8. The French fries-type food item as defined in claim 1, wherein the edible moisture barrier comprises an emulsifier.

9. The French fries-type food item as defined in claim 8, wherein the emulsifier comprises mono and di-glycerides, phospholipids, egg or soy lecithin, sucrose fatty acid esters, polyglycerol fatty acid, and any combination thereof.

10. The French fries-type food item as defined in claim 1, wherein the solid core comprises fish.

11. The French fries-type food item as defined in claim 1, wherein the solid core comprises cooked and mashed non-potato vegetable.

12. The French fries-type food item as defined in claim 11, wherein the non-potato vegetable comprises cauliflower or rutabaga.

13. The French fries-type food item as defined in claim 1, wherein the solid core comprises potatoes that are fortified with micronutrients, protein, or essential fatty acids.

14. The French fries-type food item as defined in claim 1, wherein the solid core comprises potatoes that are mixed meat, cheese, a non-potato vegetable, or any combination thereof.

15. A method for making a French fries-type food item, the method comprising:
preparing and forming a solid core;
coating the solid core with an edible moisture barrier; and
surrounding the edible moisture barrier with a potato shell;
wherein:
the potato shell has a first composition;
the solid core has a second composition; and
the first composition differs from the second composition

16. The method as defined in claim 15, wherein surrounding the solid core with the potato shell comprises:
wrapping a continuous potato sheet around the core.

17. The method as defined in claim 16, wherein surrounding the solid core with the potato shell comprises:
placing a first layer of potato material in a bottom portion of a French fry mould;
placing the core on the first layer and in a middle portion of the French fry mould;
fill the remaining space in the French fry mould with a second layer of potato material; and
compress the food material filled in the French fry mould to provide a French fry.

18. The method as defined in claim 15, wherein the edible moisture barrier comprises an edible oleaginous material or a milk-proteins-based film.

19. The method as defined in claim 15, wherein the edible moisture barrier comprises an emulsifier and the emulsifier optionally comprises mono and di-glycerides, phospholipids, egg or soy lecithin, sucrose fatty acid esters, polyglycerol fatty acid, and any combination thereof.

20. The method as defined in claim 15, further comprising fortifying the core with micronutrients, protein, or essential fatty acids.
